(19) United States
(12) Patent Application Publication
(10) Pub. No.: US 2010/0169557 A1
(43) Pub. Date: Jul. 1, 2010

(54) USING NON-VOLATILE STORAGE TO TRACK STATUS CHANGES IN OBJECTS

(76) Inventor: John Mark Morris, San Diego, CA (US)

Correspondence Address: JAMES M. STOVER;TERADATA CORPORATION, 2835 MIAMI VILLAGE DRIVE, MIAMISBURG, OH, 45342, US

(21) Appl. No.: 12/648,502

(22) Filed: Dec. 29, 2009

Related U.S. Application Data
(60) Provisional application No. 61/141,762, filed on Dec. 31, 2008.

(51) Int. Cl. G06F 12/02; G06F 12/00

(52) U.S. Cl. 711/103; 711/171; 711/E12.001; 711/E12.008; 711/E12.005

(57) ABSTRACT

A non-volatile storage device is used to track status changes in one or more items, where it is less costly to set bits in the non-volatile storage device than to reset bits. For each of the items to be tracked, at least two bits of storage space are allocated in the non-volatile storage device. One of the bits is set when the item changes status, and another of the bits is set when the item changes status again.

### CROSS-REFERENCE TO RELATED APPLICATIONS

This application claims priority from U.S. Provisional Application 61/141,762, filed on Dec. 31, 2008, by John Mark Morris.

### BACKGROUND

Solid-state, non-volatile storage devices, such as flash memory devices, are increasingly being used in applications that previously relied on disk-storage technology. One benefit to solid-state technology is that read/write access to the storage device is much faster than it is with disk drives. But solid-state storage has its drawbacks too. For example, in a flash memory device, changes in the values of individual bits of data can be made only in one direction—i.e., individual bits can only be “set” to a binary value of “0” from their initial binary value of “1.” Any time a single bit must be reset to a binary value of “1,” all of the bits in some unit size of storage (e.g., one “page” of memory in a flash device) must be reset with it. Also, the operation of resetting (or “erasing”) bits in a flash device is far more time-consuming, and thus much more costly, than the act of setting (or “writing”) the bits. For example, in some flash devices, erase operations take 10 times longer than write operations.

### SUMMARY

A non-volatile storage device is used to track status changes in one or more items, where it is less costly to set bits in the non-volatile storage device than it is to reset bits. For each of the items to be tracked, at least two bits of storage space are allocated in the non-volatile storage device. One of the bits is set when the item changes status, and another of the bits is set when the item changes status again.

Other features and advantages will become apparent from the description and claims that follow.

### BRIEF DESCRIPTION OF THE DRAWINGS

FIG. 1 is a diagram of a computer system configured for using non-volatile storage in tracking status changes in objects.

FIGS. 2, 3A and 3B are diagrams showing the use of non-volatile storage to monitor changes in a state machine.

FIG. 4 is a diagram showing the use of non-volatile storage to track the allocation of objects, such as blocks of volatile memory.

### DETAILED DESCRIPTION

Described below is a resource-management technique that leverages both the benefits and the drawbacks of solid-state storage devices, such as flash memory devices, to create a more efficient system for managing the use or operation of computing resources. In particular, the technique described here draws upon the large cost discrepancy between setting (or “writing”) and resetting (or “erasing”) the bits in certain solid-state storage devices to track status changes among resources that are managed or monitored by a computer system—or, more specifically, by tracking status changes with multiple low-cost write operations to solid-state storage for every high-cost erase operation performed. Examples of the types of resources monitored are: (1) a state machine that governs the operational state of a particular system component, and (2) a list used in managing the allocation of system resources, such as a free list that tracks the allocation of volatile memory within the computer system.

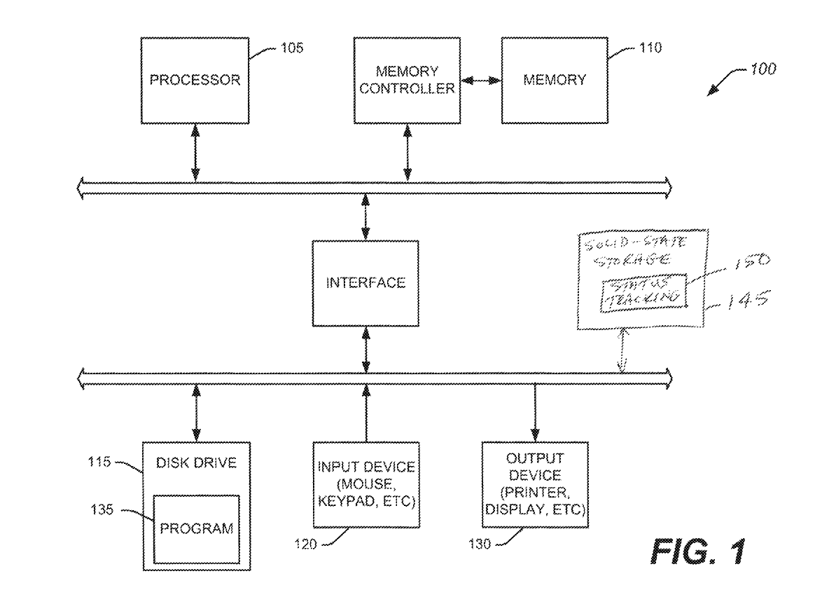

FIG. 1 shows a computer system 100 configured for execution of the resource-management technique. In general, the computer system 100 includes one or more processors 105 and one or more temporary data-storage components 110 (e.g., volatile memory modules). The computer system 100 also includes one or more persistent data-storage components 115 (e.g., optical and magnetic storage devices, such as hard and floppy disk drives, CD-ROM drives, and magnetic tape drives), one or more input devices 120 (e.g., mice, keyboards, and touch-screens), one or more output devices 130 (e.g., display consoles and printers), and other system resources 140 (e.g., network cards and other peripheral devices). The computer system 100 also includes, either in addition to or instead of the persistent data-storage components 115 described above, one or more solid-state, non-volatile storage devices 145, such as flash memory devices. The one or more processors 105 interact with the non-volatile storage devices 145 to track status changes in one or more resources managed or monitored by the computer system 100, e.g., by managing the contents of a group of bits 150 (such as a page of flash memory) to reflect the current status of these resources.

The computer system 100 includes executable program code 135 that is usually stored in one of the persistent data-storage components 115 and then copied into the temporary data-storage components 110 (e.g., system memory) at run-time. The one or more processors 105 execute the code by retrieving program instructions from memory in a prescribed order. When executing the program code, the computer receives data from the input and/or storage devices, performs operations on the data, and then delivers the resulting data to the output and/or storage devices.

In some embodiments, the computer is a special-purpose computer that performs only certain, specialized functions. In other embodiments, the computer is a general-purpose computer programmed to perform the functions needed by the service establishment.

### EXAMPLE

### State Machine

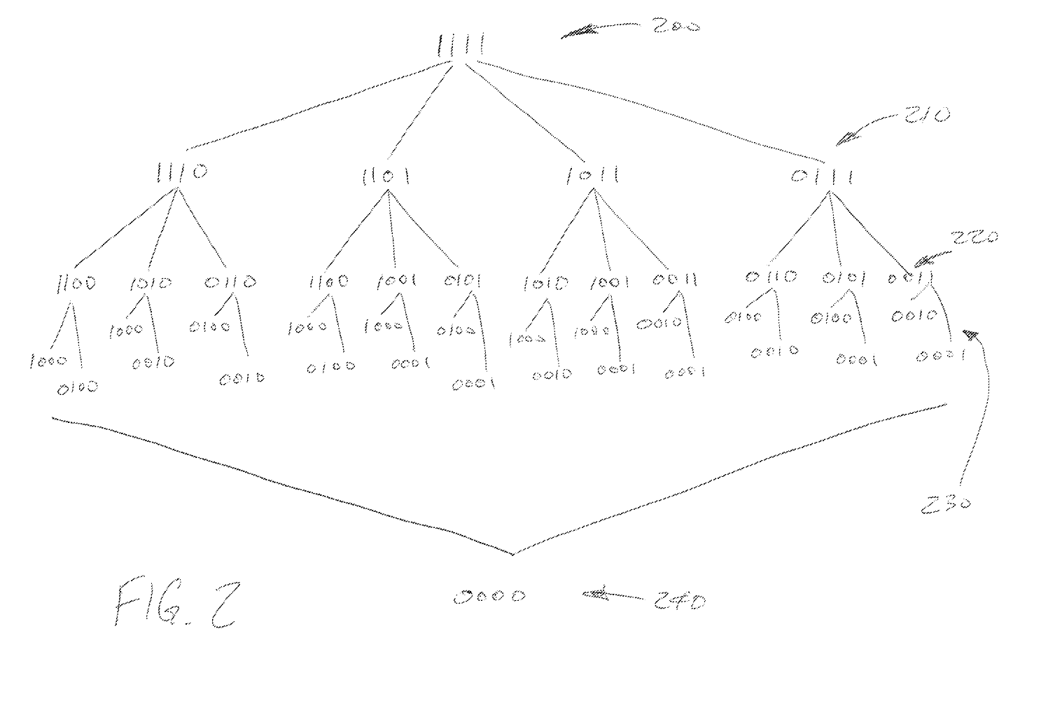

FIG. 2 shows an example of the resource-management technique as applied to a state machine that controls the operational state of some system component. In this example, the current state of the state machine is indicated by the values contained in a group of four bits (a “nibble”) within a page of flash memory. Upon performance of an erase operation that resets all bits in the page, all four bits in the nibble have a binary value of “1” (a nibble value of “1111”; step 200). From this initial state, the group of bits can track as many as four state changes through low-cost write operations before an erase operation becomes necessary. For example, starting with a nibble value of “1111,” the contents of the nibble can transition to any one of four other values (“1110,” “1101,” “1011,” “0111”) with a write to a single one of the bits (step 210). From any of these nibble values, the contents of the nibble can transition to any one of three other values with a write to another one of the bits (step 220). For example, from the value “1110,” the nibble can transition to any of the values “1100,” “1010” or “0110” by writing another bit. Likewise, from any of these three values, the nibble can transition to either of two additional values with a write to another one of the bits (step 230)—e.g., from a value of “1100” to either “1000” or “0100” with a write to a single bit. At this point, because only one of the four bits in the nibble has not been written, the nibble can transition to only one value, “0000,” through a write operation (step 240). If any further changes value are required, the nibble (and thus the full page of flash memory) is erased and reset to its initial value (“1111”).

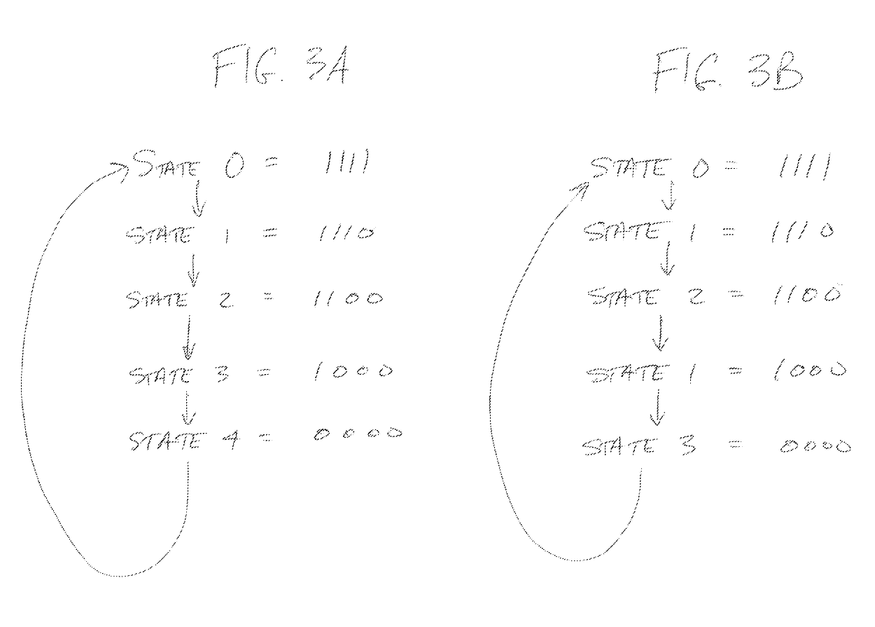

FIGS. 3A and 3B show two possible mappings of state transitions by the system resource to the value contained in the nibble. In the example of FIG. 3A, the system resource undergoes four transitions involving five unique states—State 0, State 1, State 2, State 3 and State 4—between erase operations. The resource begins in State 0 and the nibble has its initial value (“1111”). When the resource transitions to State 1, one bit of the nibble is written, and the nibble transitions to one of the four possible values shown in FIG. 2 (“1110” in this example). When the resource transitions to State 2, another bit of the nibble is written, and the nibble transitions to one of the three values that are possible at this point (“1100” in this example). When the resource transitions to State 3, another bit of the nibble is written, and the nibble transitions to one of the two values possible at this point (“1000” in this example). When the resource transitions to State 4, the final bit of the nibble is written and the nibble transitions to its “all-written” value, “0000.” From here, the system resource will return to State 0, and the nibble will be erased.

In the example of FIG. 3B, the system resource undergoes four transitions involving only four unique states—State 0, State 1, State 2 and State 3—where one of the states (State 1) occurs twice and is represented by two different nibble values (“1110” and “1000”). As before, the resource begins in State 0 and the nibble has its initial value (“1111”). When the resource transitions to State 1 the first time, one bit of the nibble is written and the nibble transitions to one of the four possible values (“1110” in this example). When the resource transitions to State 2, another bit of the nibble is written and the nibble transitions to one of the three values that are possible at this point (“1100” in this example). The resource then returns to State 1, and another bit of the nibble is written, causing the nibble to transition to one of the two value possible at this point (“1000” in this example). The resource then transitions from State 1 to State 3, causing the last bit of the nibble to be written and the nibble to transition to its all-written value “0000.” From here, the system resource will return to State 0, and the nibble will be erased.

### EXAMPLE

### Tracking the Allocation of Objects

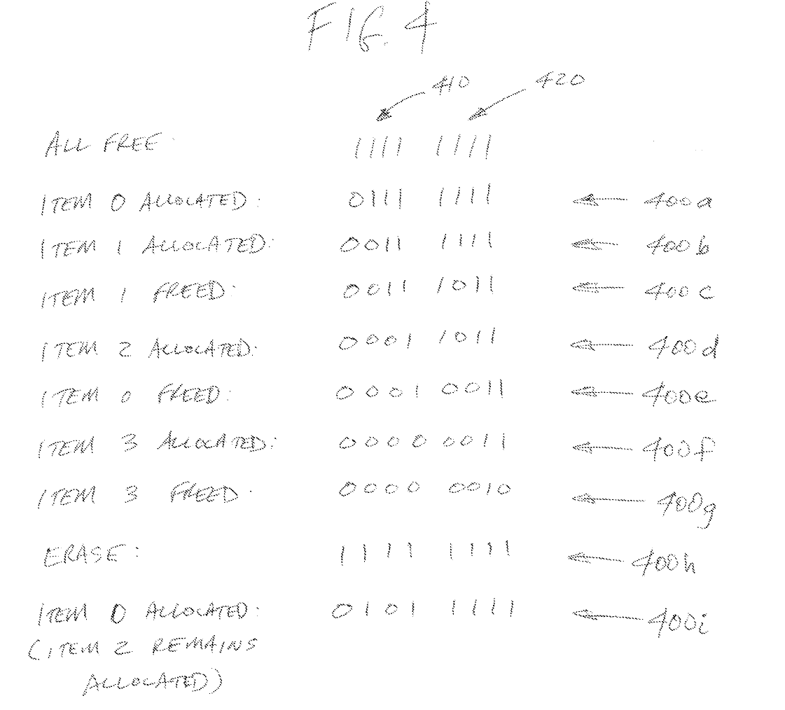

FIG. 4 shows an example of the resource-management technique when used in tracking the allocation of N objects (e.g., N blocks of memory) with 2N bits in non-volatile storage. For purposes of illustration, N=4 in this example (four objects tracked using eight bits, or one byte, of storage), but N could be any number called for by the application in which the technique is being applied.

In the example shown here, of the 2N bits used to track the allocation of the N objects, the first N bits are used to indicate whether any of the N objects has been allocated, and the second N bits are used to indicate whether any of the N objects have been freed. Each of the bits in the first N bits corresponds to one of the N objects and to one of the bits in the second N bits. More specifically, when eight bits are used to track the allocation of four objects, the first (leftmost) bit in the first four bits (the first nibble 410) and the first (leftmost) bit in the second nibble 420 both correspond to the first object (Item 0). Likewise, the second bit in the first nibble 410 and the second bit in the second nibble 420 both correspond to the second object (Item 1); the third bit in each nibble corresponds to the third object (Item 2); and the fourth (rightmost) bit in each nibble corresponds to the fourth object (Item 3).

Before the allocation process begins, the eight bits of storage have an initial value of “1111 1111” (their “erased” value). When the first object (Item 0) is allocated, the first bit in the first nibble 410 is written to indicate that this has occurred (byte value of “0111 1111”; step 400a). The second object (Item 1) is then allocated, and the second bit in the first nibble 410 is also written (byte value of “0011 1111”; step 400b). At some point thereafter, the second object (Item 1) is freed, and the second bit in the second nibble 420 is written to show that this has occurred (byte value “0011 1011”; step 400c). At this point, the two bits corresponding to the first object (Item 0) have the value “01” (only one is written), the two bits corresponding to the second object (Item 1) have the value “00” (both are written), and the two bits corresponding to the third object (Item 2) as well as those corresponding to the fourth object (Item 3) have the value “11” (neither is written). The “one-written” value of “01” indicates that the corresponding object has been allocated and remains that way; the “both-written” value of “00” indicates that the corresponding object has been allocated and freed (and thus is available for allocation again); and the “neither-written” value of “11” indicates that the corresponding object has not yet been allocated and thus is available for allocation.

At some point after the second object (Item 1) is freed, the third object (Item 2) is allocated, and the third bit in the first nibble 410 is written (byte value “0001 1011”; step 400d). The first object (Item 0) is then freed, and the first bit in the second nibble 420 is written (byte value “0001 0011”; step 400e). The fourth object (Item 3) is then allocated, and the fourth bit in the first nibble 410 is written (byte value “0000 0011”; step 400f). The fourth object is then freed, and the fourth bit in the second nibble 420 is written (byte value “0000 0010”; step 400g). At this point, all of the objects have been allocated, and only the third object (Item 2) remains that way. The other objects all have been freed and await further allocation, and the byte value of “0000 0010” indicates that this is the case—all of the bits in the first nibble 410 have been written, indicating that all four objects have been allocated, and all but the third bit in the second nibble 420 has been written, indicating that only the third object (Item 2) has not been freed.

At some point after the fourth object has been freed, the system reallocates the first object (Item 0). Because both of the bits corresponding to the first object have been written, the system must reset these bits. Doing so requires the system to perform a high-cost erase operation and resets the byte value to “1111 1111” (step 400h). The system then immediately follows the erase operation with a write to two of the bits in the first nibble 410 (step 400i)—the bit corresponding to the reallocated first object (Item 0), and the bit corresponding to the third object (Item 2), which was previously allocated and has not yet been freed (byte value “0101 1111”).

In this example, all four objects have been allocated and one has been reallocated, and only a single erase operation has been performed. For a system in which the cost of erasing the non-volatile storage device is ten times (10×) greater than the cost of a write operation, using eight bits of storage instead of four bits to track the allocation of four objects cuts the cost of the tracking process in half in this example. In particular, in a system in which only four bits of storage are used to track the allocation of the four objects, an erase operation would be required each time any of allocated objects were freed. Therefore, the cost in arriving at this point in the example would be: 1 unit (a write to set the first bit) when Item 0 is allocated (“0111”), 1 unit (a write to set the second bit) when Item 1 is allocated (“0011”), 10 units (an erase to reset the bits) plus 1 unit (a write to set the first bit) when Item 1 is freed (“0111”), 1 unit (a write to set the third bit) when Item 2 is allocated (“0101”), 10 units (an erase to reset the bits) plus 1 unit (a write to set the third bit) when Item 0 is freed (“1101”), 1 unit (a write to set the fourth bit) when Item 3 is allocated (“1100”), 10 units (an erase to reset the bits) plus 1 unit (a write to set the third bit) when Item 3 is freed (“1101”), and 1 unit (a write to set the first bit) when Item 0 is reallocated (“0101”). In this example, all items have been allocated at least once, Item 0 has been freed and reallocated, Item 1 and Item 3 have been freed, and Item 2 remains allocated, and the total cost to get to this point is 38 units:

1+1+(10+1)+1+(10+1)+1+(10+1)+1=38 units.

On the other hand, when eight bits are used to track allocation of four objects, the cost of arriving at this point is: 1 unit (a write to the first nibble) when Item 0 is allocated, 1 unit (a write to the first nibble) when Item 1 is allocated, 1 unit (a write to the second nibble) when Item 1 is freed, 1 unit (a write to the first nibble) when Item 2 is allocated, 1 unit (a write to the second nibble) when Item 0 is freed, 1 unit (a write to the first nibble) when Item 3 is allocated, 1 unit (a write to the second nibble) when Item 3 is freed, and 10 units (an erase) plus 1 unit (a write to the first nibble) when Item 1 is reallocated, for a total cost of 18 units:

1+1+1+1+1+1+1+(10+1)=18 units.

### OTHER EXAMPLES

The costs associated with this technique for tracking allocation of objects can be improved even further by allocating one erased page of non-volatile storage space for each object to be tracked. Each erased page of storage space includes an even number of bits, and the bits in the page are set sequentially, one at a time, each time the corresponding object is allocated or freed. At the outset, all bits in the page have a binary value of “1.” The first time that the corresponding object is allocated, the first bit in the page is set to a binary value of “0.” When the object is freed, the second bit in the page is set. When the object is allocated again, the third bit in the page is set, and when the object is freed again, the fourth bit is set, and so on, with the setting of bits continuing in this manner each time the object is allocated or freed until no bits remain in the page. In this embodiment, the system needs to evaluate only whether an odd or even number of bits have been set to assess whether the corresponding object is allocated or free. If an odd number of bits have been set, the object is allocated; if an even number have been set, the object is free. When all of the bits have been set, the object is free, and the page must be erased (or “reset” to its initial value) when the system is ready to reallocate the object. Using this technique reduces the number of page-erase operations required for each object by N/2, where N is the number of bits in the page.

Yet another example allows multiple objects to be tracked by a full page of storage space, with each object receiving an even number of the bits in the page. In some embodiments, the bits on the page are allocated evenly across all of the objects to be tracked by the page, and in other embodiments the bits are allocated unevenly (i.e., one object has more bits dedicated to it than another object). This example is similar to the previous example in that the each time one of the objects changes status, one of the bits allocated to it is set, with an odd number of set bits indicating one status and an even number of set bits indicating the other status. This example differs from the previous example in that, when the bits allocated to one of the objects must be erased, the bits allocated to other objects must be erased as well. This example allows the system to balance inefficiency in page-erase operations against the amount of non-volatile storage used in tracking the status of objects. Ideally, when the statuses of multiple objects are to be tracked with a single page of storage, the system will allocate the bits on the page in a manner that minimizes the number of unset bits that exist when a page-erase operation takes place.

The text above describes one or more specific embodiments of a broader invention. The invention also is carried out in a variety of alternative embodiments and thus is not limited to those described here. Many other embodiments are also within the scope of the following claims.

1. A method of using a non-volatile storage device to track status changes in one or more items, where it is less costly to set bits in the non-volatile storage device than to reset bits, the method comprising, for each of the items to be tracked:
allocating at least two bits of storage space in the non-volatile storage device;
setting one of the bits when the item changes status; and
setting another of the bits when the item changes status again.

2. The method of claim 1, further comprising resetting the bits allocated to the item after all of the bits allocated to the item have been set.

3. The method of claim 1, where allocating at least two bits includes allocating exactly two bits for the item.

4. The method of claim 3, further comprising resetting the bits allocated to the item when the item changes status a third time.

5. The method of claim 1, where allocating at least two bits includes allocating a group of more than two bits for the item.

6. The method of claim 5, further comprising setting another of the bits in the group each time the item changes status.

7. The method of claim 6, where the item returns to a status that it previously held thus causing a certain combination of bits in the group to be set, and where the certain combination of bits differs from a combination of bits that were set when the item previously held that status.

8. The method of claim 5, where allocating a group of more than two bits includes allocating an even number of bits for the item.

9. The method of claim 8, where the item has two possible states, and where the method further comprises:
concluding that the item is in a first state when an even number of bits in the group have been set; and
concluding that the item is in a second state when an odd number of bits in the group have been set.

10. The method of claim 1, where the storage device comprises a flash memory device, and where allocating at least two bits of storage space comprises allocating a full page of flash memory for two of more of the items.

11. The method of claim 10, where allocating a full page of flash memory includes allocating the same number of bits to each of the two or more items.

12. The method of claim 10, where allocating a full page of flash memory includes allocating more bits to one of the items than are allocated to another of the items.

13. The method of claim 10, further comprising erasing the page of flash memory after all of the bits allocated to one of the items have been set.

14. The method of claim 1, where tracking status changes in one or more items includes tracking allocation of one or more computing resources, and where, for each of the computing resources to be allocated:
allocating at least two bits of storage space in the non-volatile storage device includes allocating exactly two bits of storage space;
setting one of the bits includes setting a first one of the bits when the computing resource is allocated; and
setting another of the bits includes setting a second one of the bits when the computing resource is freed.

15. The method of claim 14, further comprising resetting both of the bits when the computing resource is to be allocated again.

16. The method of claim 14, where tracking allocation of one or more computer resources includes tracking allocation of a given number (N) of computing resources;
where allocating at least two bits of storage space in the non-volatile storage device includes allocating 2N bits, with exactly two bits allocated for each of the N computing resources;
where setting one of the bits includes, for each computing resource, setting a first one of the bits allocated to the computing resource when the computing resource is allocated; and
where setting another of the bits includes setting a second one of the bits allocated to the computing resource when the computing resource is freed.

17. The method of claim 16, further comprising resetting all of the 2N bits when any one of the computing resources has been allocated and freed and is to be allocated again.

18. The method of claim 17, further comprising, after resetting all of the 2N bits, for each of the computing resources that had been allocated but not yet freed, immediately setting the first one of the bits allocated to the computing resource.
